(19) United States
(12) Patent Application Publication
(10) Pub. No.: US 2017/0023171 A1
(43) Pub. Date: Jan. 26, 2017

(54) ENGINE STAND WITH REAR MOUNT SUPPORT

(71) Applicant: Caterpillar Inc., Peoria, IL (US)

(72) Inventor: Zeeshan Khan, Edwards, IL (US)

(73) Assignee: Caterpillar Inc., Peoria, IL (US)

(21) Appl. No.: 14/803,243

(22) Filed: Jul. 20, 2015

(51) Int. Cl. F16M 11/26; B65D 61/00; F16M 11/04

(52) U.S. Cl. CPC F16M 11/26; F16M 11/041; B65D 61/00

(57) ABSTRACT

A stand for an engine is provided. The stand includes a base member having a first end and a second end. The base member also includes a front post fixedly connected to the base member at the first end. The base member further includes a rear support system fixedly connected to the base member at the second end. The rear support system includes two sleeve members and two rear posts, such that each rear post is slidably coupled to a sleeve member, and such that each rear post includes a clamp configured to hold a rear mount of the engine.

### TECHNICAL FIELD

The present disclosure relates to an engine stand, and more particularly, to an engine stand with rear mount support.

### BACKGROUND

Engines generally have a variety of sizes, shapes and weights. Engines are generally manufactured separately and need to be shipped to a location where they can be installed into a vehicle. During shipping, the size, shape and weight of an engine may present a challenge and require specialized equipment. Such specialized equipment may be expensive to make, require special training and skill to operate, and may increase the time taken for loading and unloading the engine on and off the equipment. Some engines include a variety of mounts on either front ends or rear ends and require additional support system to be able to remain upright and secure during shipping or transportation. Engines containing different size mounts and at different heights require multiple stands during shipping.

U.S. Pat. No. 4,804,162 describes an engine support containing an adjustable base fitted with legs which adjust to varying heights. The legs include on their tops, rotatable cradles sized to receive an engine mount. The engine support can be wheeled underneath an elevated vehicle and an engine and its mount is lowered onto the cradles. The engine can then be wheeled away from the vehicle.

### SUMMARY OF THE DISCLOSURE

In one aspect of the present disclosure, a stand for an engine is provided. The stand includes a base member having a first end and a second end. The base member also includes a front post fixedly connected to the base member at the first end. The base member further includes a rear support system fixedly connected to the base member at the second end. The rear support system includes two sleeve members and two rear posts, such that each rear post is slidably coupled to a sleeve member, and such that each rear post includes a clamp configured to hold a rear mount of the engine.

In another aspect of the present disclosure, a method of mounting an engine on a stand is provided. The method includes providing a stand including a base member that includes a first end and a second end. The base member includes a front post fixedly connected to the base member at the first end, and a rear support system fixedly connected to the base member at the second end. The rear support system includes two sleeve members and two rear posts, such that each rear post is slidably coupled to a sleeve member, and such that each rear post has a clamp configured to hold a rear mount of the engine. The method further includes connecting a front end of the engine to the front post of the stand and connecting a rear end of the engine to the rear support system of the stand.

In yet another aspect of the present disclosure, a stand for an engine is provided. The stand includes a base member having a first end and a second end. The base member also includes a front post fixedly connected to the base member at the first end. The base member further includes a rear support system fixedly connected to the base member at the second end. The rear support system includes two sleeve members and two rear posts, such that each rear post is slidably coupled to a sleeve member, and such that each rear post includes a clamp configured to hold a rear mount of the engine. The rear post is configured to be vertically adjusted at multiple preset positions. Each rear post includes at least one steel saddle covered with a rubber padding. The clamp includes a locking pin mechanism, and is configured to hold rear mounts of a plurality of diameters. The clamp includes multiple spaced holes for receipt of a locking pin, and for adjusting an opening of the clamp over at least three different clamping positions. The front post is configured to hold trunnions of two different heights.

Other features and aspects of this disclosure will be apparent from the following description and the accompanying drawings.

### BRIEF DESCRIPTION OF THE DRAWINGS

FIG. 1 is a perspective view of a stand with a rear support system including an engine with a rear mount supported on the stand, according to one embodiment of the present disclosure;

FIG. 2 is a perspective view of the stand having the rear support system, according to one embodiment of the present disclosure;

FIG. 3 is an enlarged view of the rear support system, according to one embodiment of the present disclosure;

FIG. 4 is a perspective view of a rear post, according to one embodiment of the present disclosure;

FIG. 5 is a perspective view of a rear mount of an engine clamped to the rear support system, according to another embodiment of the present disclosure; and

FIG. 6 is a method of mounting the engine on the stand, according to one embodiment of the present disclosure.

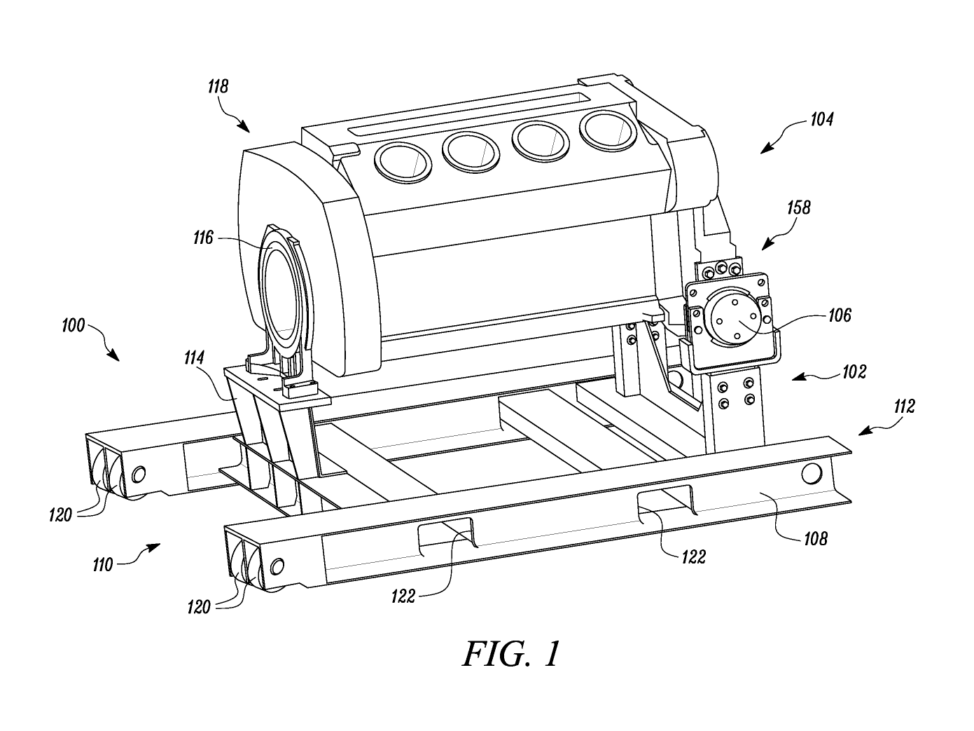

### DETAILED DESCRIPTION

Wherever possible, the same reference numbers will be used throughout the drawings to refer to the same or the like parts. FIG. 1 illustrates a perspective view of a stand 100 with a rear mount support system 102 depicting an exemplary engine 104 with a rear mount 106 supported on the stand 100, according to one embodiment of the present disclosure. The stand 100 includes a base member 108. The base member 108 includes a first end 110 and a second end 112. The stand 100 further includes a front post 114 fixedly connected to the base member 108 at the first end 110. The base member 108 also includes the rear support system 102 fixedly connected thereto at the second end 112.

The front post 114 is configured to hold a trunnion 116, which in turn is coupled to a front end 118 of the engine 104. In some embodiments, the front post 114 may be configured to hold trunnions of two different heights. The stand 100 is configured to hold the engine 104 during shipping.

As shown in FIG. 1, the base member 108 includes a set of wheels 120. The set of wheels 120 allows the stand 100 with or without the engine 104 to be moved back and forth over a ground surface. The base member 108 further includes a plurality of slots 122. The slots 122 allow the stand 100 with or without the engine 104 to be moved. For example, the slots 122 are configured to engage with forks of a fork lift used during loading or unloading of cargo during shipping. In certain embodiments, the stand 100 with or without the engine 104, may be loaded onto pallets (not shown) during shipping. In an alternative embodiment, the stand 100 with or without the engine 104, may be shipped without the need for pallets.

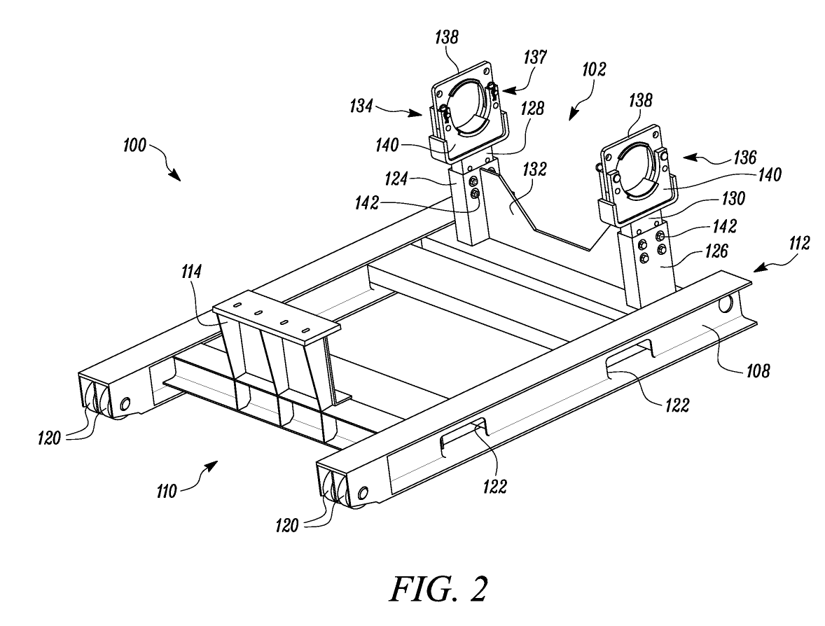

FIG. 2 illustrates a perspective view of the stand 100 depicting the base member 108, the front post 114 and the rear support system 102, according to an embodiment of the present disclosure. As depicted in FIG. 2, the rear support system 102 further includes two sleeve members 124 and 126. In addition, two rear posts 128 and 130 are also depicted, such that the rear post 128 is slidably coupled to the sleeve member 124 and the rear post 130 is slidably coupled to the sleeve member 126. The rear support system 102 also includes a wall member 132 as shown in FIG. 2. The wall member 132 is attached to each of the sleeve members 124 and 126. Each of the rear posts 128 and 130 further includes clamps 134 and 136, each configured to hold the rear mount 106 of the engine 104. Each of the clamps 134 and 136 includes an upper end 138 and a lower end 140.

The rear posts 128 and 130 are slidably coupled to the sleeve members 124 and 126, respectively, using a plurality of nuts and bolts 142. In another embodiment, the rear posts 128 and 130 may be slidably coupled to the sleeve members 124 and 126, respectively, via fastening members, such as, nuts and bolts. In certain embodiments, the rear posts 128 and 130 may be adjustable relative to the sleeve members 124 and 126, respectively. For example, the rear posts 128 and 130 may be configured to be vertically adjusted at multiple preset positions.

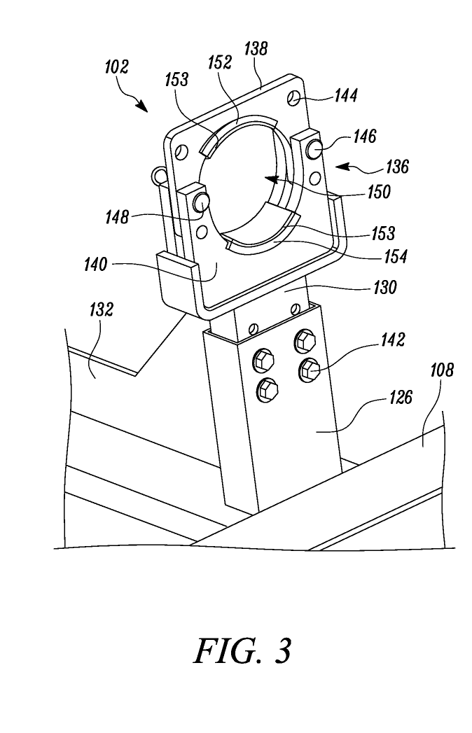

FIG. 3 illustrates an enlarged view of the rear support system 102 including the sleeve member 126, the rear post 130 and the clamp 136, according to one embodiment of the present disclosure. The clamp 136 includes multiple spaced holes 144 for receipt of locking pins 146 and 148, and for adjusting an opening 150 of the clamp 136 to multiple clamping positions. Each of the upper end 138 and the lower end 140 of the clamp 136 may be adjusted using multiple preset clamping positions to adjust the opening 150. In some embodiments, the clamp 136 may include a locking pin mechanism 137. The upper end 138 of the clamp 136 may be adjusted or locked into a desired clamping position with the lower end 140 of the clamp 136 using the locking pin mechanism 137. For example, the opening 150 may be adjusted, by sliding the locking pins 146 and 148 through the holes 144. The desired clamping position may vary based on, for example, an outer diameter of the rear mount 106 of the engine 104. The clamp 136 is configured to hold rear mounts of a plurality of diameters. Moreover, the clamp 136 is configured to be adjusted over at least three different clamping positions.

As shown in FIG. 3, the rear post 130 includes at least one steel saddle 152 covered with a rubber padding 153. The rear post 130 includes two steel saddles 152 and 154 covered with the rubber padding 153. The upper end 138 and the lower end 140 of the clamp 136 include the steel saddles 152 and 154, respectively. The steel saddles 152 and 154 allow the rear mount 106 of the engine 104 to be clamped securely while protecting the engine mount 106 from damage. The rubber paddings 153 covering the steel saddles 152 and 154 provide protection of the rear mount 106 of the engine 104 while reducing the wear of steel saddles 152 and 154, and thereby enhancing the durability of the stand 100.

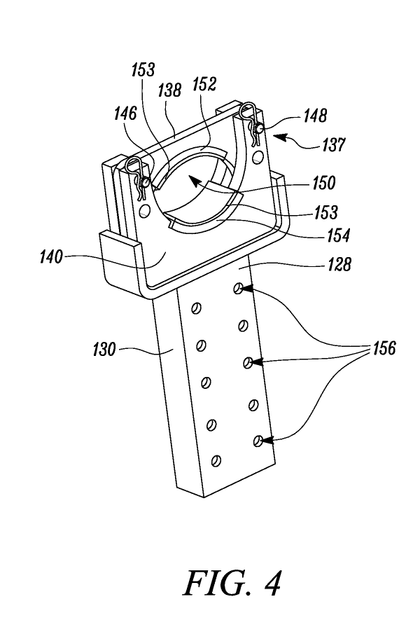

FIG. 4 illustrates a perspective view showing a back side of the rear post 130 and the clamp 136 of FIG. 3, according to one embodiment of the present disclosure. The rear post 130 includes a plurality of multiple preset positions 156 that allow the rear post 130 to be vertically adjusted along the sleeve member 126. The rear posts 128 and 130 may be vertically adjusted over a range of 0.5 to 10 inches.

FIG. 4 further depicts the locking pins 146 and 148 of the locking pin mechanism 137 that allows the upper end 138 of the clamp 136 to be adjusted or locked into the desired clamping position with the lower end 140 of the clamp 136. Alternate mechanism for adjusting or locking the clamp 136 other than the one shown may be available to a skilled artisan and are within the scope of this disclosure.

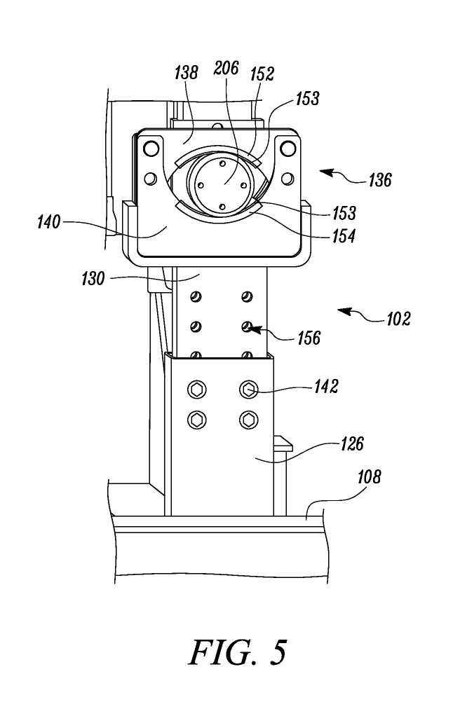

FIG. 5 illustrates a perspective view of a rear mount 206 of an engine (not shown) clamped to the rear support system 102, according to another embodiment of the present disclosure. As shown in FIG. 5, when the rear mount 206 of the engine is of a smaller diameter, the upper end 138 of the clamps 134, 136 may be adjusted or locked into a desired clamping position with the lower end 140 of the clamps 134, 136, such that a secure grip may be obtained. In addition, the rear posts 128 and 130 may be vertically adjusted by sliding the rear posts 128 and 130 up or down the sleeve members 124 and 126, respectively, and securing the rear posts 128 and 130 at a desired preset position such that the engine is securely maintained during the shipping.

### INDUSTRIAL APPLICABILITY

The present disclosure relates to the stand 100 having the rear posts 128 and 130 slidably coupled to the sleeve members 124 and 126, respectively, such that each rear post 128, 130 may be vertically adjusted to the multiple preset positions 156 by sliding the rear posts 128 and 130 to the desired height, and locking the rear posts 124 and 126 at that height using, for example, nuts and bolts 142. The opening 150 of each clamp 134, 136 may be adjusted to multiple preset clamping positions and locked at the desired clamping position using the locking pins 146 and 148. The opening 150 is adjusted to accommodate the rear mount 106, 206 of the engine 104, and to securely hold the rear mount 106, 206 during shipping and transportation of the engine 104. The steel saddles 152 and 154 covered with the rubber padding 153 can provide a secure hold while avoiding wear of the clamps 134, 136.

The stand 100 can be manufactured in a cost-effective manner and using known materials and methods available in the art. For example, the stand 100 can be made using mild steel, other grades of steel or alternative materials that are commercially available, and using forging, fabricating and welding methods known in the art.

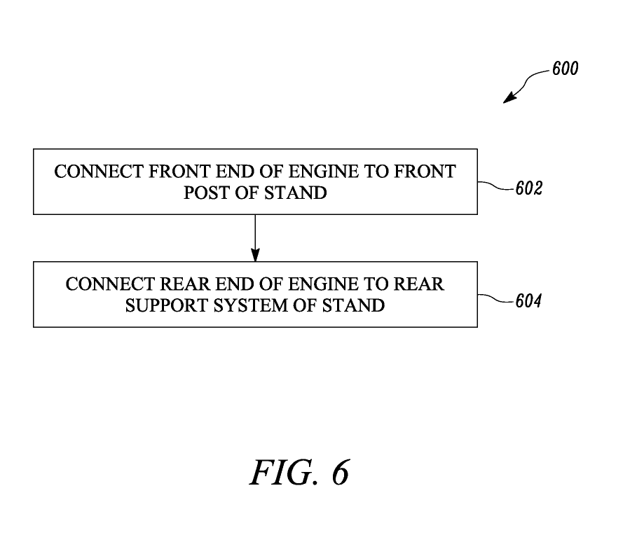

FIG. 6 illustrates a flowchart for a method 600 of mounting the engine 104 on the stand 100, according to one embodiment of the present disclosure. The method 600 will be explained with reference to the stand 100, but the method 600 is also applicable to the stand 100 without any limitations. At step 602, the method 600 includes connecting the front end 118 of the engine 104 to the front post 114 of the stand 100. The method 600 may include connecting the front end 118 of the engine 104 via the trunnion 116. The stand 100 is disposed on the ground surface. The stand 100 includes the base member 108 having the front post 114 fixedly connected to the base member 108 at the first end 110 and the rear support system 102 fixedly connected to the base member 108 at the second end 112. The rear support system 102 includes the rear posts 128 and 130 slidably coupled to the sleeve members 124 and 126, respectively, and the clamps 134 and 136 hold the rear mount 106, 206 of the engine 104. The wall member 132 provides additional support to the rear support system 102 and to the stand 100 by, for example, enhancing the overall strength and durability of the stand 100.

At step 604, the method 600 includes connecting a rear end 158 of the engine 104 to the rear support system 102 of the stand 100. The method 600 may also include, vertically adjusting each of the rear posts 128 and 130 to the preset position. The method 600 may further include, vertically adjusting each of the rear posts 128 and 130 over the range of 0.5 to 10 inches. The rear end 158 of the engine 104 may include a pair of rear mounts 106, 206. The method 600 may include, adjusting the clamps 134 and 136 on the rear posts 128 and 130, respectively, to align with the rear mounts 106, 206 of the engine 104. The method 600 may also include, adjusting the clamping position of the clamps 134 and 136 via the locking pin mechanism 137 to hold the rear mounts 106, 206 of the engine 104. The steel saddles 152 and 154 allow the rear mounts 106, 206 of the engine 104 to be clamped securely while reducing wear, thereby enhancing the durability of the stand 100. The rubber paddings 153 provide protection of the rear mount 106, 206 while further reducing the wear of the steel saddles 152 and 154. The rubber paddings 153 are easily replaceable allowing for easier and cheaper maintenance of the stand 100 and may alleviate the need to replace more expensive components of the clamps 124, 136.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A stand for an engine, the stand comprising:
a base member comprising a first end and a second end;
a front post fixedly connected to the base member at the first end; and
a rear support system fixedly connected to the base member at the second end, the rear support system comprising:
two sleeve members; and
two rear posts, wherein each rear post is slidably coupled to a sleeve member, and wherein each rear post comprises a clamp configured to hold a rear mount of the engine.

2. The stand of claim 1, wherein the rear posts are adjustable.

3. The stand of claim 1, wherein the rear posts are configured to be vertically adjusted at multiple preset positions.

4. The stand of claim 4, wherein the rear posts are vertically adjusted over a range of 0.5 to 10 inches.

5. The stand of claim 1, wherein each rear post comprises at least one steel saddle covered with a rubber padding.

6. The stand of claim 1, wherein the clamp comprises a locking pin mechanism.

7. The stand of claim 1, wherein the clamp is configured to hold rear mounts of a plurality of diameters.

8. The stand of claim 1, wherein the clamp comprises multiple spaced holes for receipt of a locking pin, and for adjusting an opening of the clamp to multiple clamping positions.

9. The stand of claim 1, wherein the clamp is configured to be adjusted over at least three different clamping positions.

10. The stand of claim 1, wherein the front post is configured to hold trunnions of two different heights.

11. The stand of claim 1 configured to hold the engine during shipping.

12. A method of mounting an engine on a stand, the method comprising:
connecting a front end of the engine to a front post of the stand, the stand including:
a base member comprising a first end and a second end, wherein the front post is fixedly connected to the base member at the first end; and
a rear support system fixedly connected to the base member at the second end, the rear support system comprising:
two sleeve members; and
two rear posts, wherein each rear post is slidably coupled to a sleeve member, and wherein each rear post comprises a clamp configured to hold a rear mount of the engine; and
connecting a rear end of the engine to the rear support system of the stand.

13. The method of claim 12 further comprising, connecting the front end of the engine via a trunnion.

14. The method of claim 12 further comprising, vertically adjusting each of the rear posts to a preset position.

15. The method of claim 12 further comprising, vertically adjusting each of the rear posts over a range of 0.5 to 10 inches.

16. The method of claim 12, wherein the rear end of the engine comprises two rear mounts.

17. The method of claim 16 further comprising, adjusting the clamps on the rear posts to align with the rear mounts of the engine.

18. The method of claim 17 further comprising, adjusting a clamping position of the clamps via a locking pin mechanism to hold the rear mounts of the engine.

19. A method of shipping an engine mounted on a stand according to claim 11.

20. A stand for an engine, the stand comprising:
a base member comprising a first end and a second end;
a front post fixedly connected to the base member at the first end; and
a rear support system fixedly connected to the base member at the second end, the rear support system comprising:
two sleeve members; and
two rear posts, wherein each rear post is slidably coupled to a sleeve member, and wherein each rear post comprises a clamp configured to hold a rear mount of the engine, wherein each rear post is configured to be vertically adjusted at multiple preset positions, wherein each rear post comprises at least one steel saddle covered with a rubber padding, wherein the clamp comprises a locking pin mechanism, wherein the clamp is configured to hold rear mounts of a plurality of diameters, wherein the clamp comprises multiple spaced holes for receipt of a locking pin, and for adjusting an opening of the clamp over at least three different clamping positions, and wherein the front post is configured to hold trunnions of two different heights.
